(19) United States
(12) Patent Application Publication
(10) Pub. No.: US 2025/0384879 A1
(43) Pub. Date: Dec. 18, 2025

(54) MULTIMODAL VIRTUAL ASSISTANT

(71) Applicant: GM GLOBAL TECHNOLOGY OPERATIONS LLC, Detroit, MI (US)

(72) Inventors: Ohad Akiva, Kfar Saba (IL); Omer Tsimhoni, Bloomfield Hills, MI (US); Ron Hecht, Raanana (IL); Ravid Erez, West Bloomfield, MI (US); Gershon Celniker, Netanya (IL)

(73) Assignee: GM GLOBAL TECHNOLOGY OPERATIONS LLC, Detroit, MI (US)

(21) Appl. No.: 18/742,083

(22) Filed: Jun. 13, 2024

(51) Int. Cl. G10L 15/22; G10L 15/30

(52) U.S. Cl. CPC G10L 15/22; G10L 15/30; G10L 2015/223; G10L 2015/225

(57) ABSTRACT

Methods and systems are provided that include one or more first sensors, one or more second sensors, and a processor of a vehicle. The one or more first sensors have a first modality, and are configured to receive a first input from a passenger of the vehicle pertaining to a request. The processor is configured to at least facilitate providing instructions to the passenger for providing an additional input pertaining to the request within a predetermined amount of time. The one or more second sensors have a second modality that is different from the first modality, and are configured to receive a second input from the passenger pertaining to the request. The processor is further configured to at least facilitate interpreting the second input; and performing a vehicle action corresponding to the request based on the interpreting of the second input.

### INTRODUCTION

The technical field generally relates to platforms such as vehicles and, more specifically, to methods and systems for facilitating interaction with a passenger of the vehicle via a virtual assistant.

Many vehicles today utilize techniques for interaction with passengers of the vehicle. However, in certain situations, such techniques may not always be optimal.

Accordingly, it is desirable to provide improved methods and systems for facilitating interaction with passengers, such as for vehicles. Furthermore, other desirable features and characteristics of the present disclosure will become apparent from the subsequent detailed description and the appended claims, taken in conjunction with the accompanying drawings and the foregoing technical field and background.

### SUMMARY

In an exemplary embodiment, a method is provided that includes receiving, via one or more first sensors of a vehicle, a first input from a passenger of the vehicle pertaining to a request, the one or more first sensors having a first modality; providing instructions to the passenger for providing an additional input pertaining to the request within a predetermined amount of time, via a processor of the vehicle; receiving, via one or more second sensors of the vehicle, a second input from the passenger pertaining to the request, in response to the instructions, within the predetermined amount of time, the one or more second sensors having a second modality that is different from the first modality; interpreting the second input, via the processor; and performing a vehicle action corresponding to the request based on the interpreting of the second input, via the processor.

Also in an exemplary embodiment, the predetermined amount of time is determined via the processor based on a prior history via adaptive learning.

Also in an exemplary embodiment, the first input includes a speech command from the passenger, and is received via one or more microphones of the vehicle.

Also in an exemplary embodiment, the instructions include audio instructions that are provided via a speaker of the vehicle that is coupled to the processor.

Also in an exemplary embodiment, the instructions include visual instructions that are provided via a display screen of the vehicle that is coupled to the processor.

Also in an exemplary embodiment, the instructions inform the passenger to engage a particular input device in a particular directional manner within the predetermined amount of time, based at least in part on a proximity of the passenger to the particular input device; and the second input is received via one or more input sensors as to engagement of the particular input device in the particular directional manner within the predetermined amount of time.

Also in an exemplary embodiment, the instructions inform the passenger to engage the particular input device that is usually used for a first vehicle function; and the second input is received via the one or more input sensors as to the engagement of the input device for executing the request with respect to a second vehicle function that is different from and unrelated to the first vehicle function.

Also in an exemplary embodiment, the instructions inform the passenger to perform a particular gesture, unrelated to any input devices of the vehicle, within the predetermined amount of time; and the second input is received via one or more cameras as to the particular gesture within the predetermined amount of time.

Also in an exemplary embodiment, the instructions inform the passenger to swipe a steering wheel of the vehicle via a hand or finger of the passenger within the predetermined amount of time; and the second input is received via the one or more cameras as to the swiping of the steering wheel of the vehicle via the hand or finger of the passenger within the predetermined amount of time.

In another exemplary embodiment, a system is provided that includes one or more sensors of a vehicle, one or more second sensors of the vehicle, and a processor of the vehicle. The one or more first sensors have a first modality, and are configured to receive a first input from a passenger of the vehicle pertaining to a request. The processor is configured to at least facilitate providing instructions to the passenger for providing an additional input pertaining to the request within a predetermined amount of time. The one or more second sensors have a second modality that is different from the first modality, and are configured to receive a second input from the passenger pertaining to the request. The processor is further configured to at least facilitate interpreting the second input; and performing a vehicle action corresponding to the request based on the interpreting of the second input.

Also in an exemplary embodiment, the processor is further configured to at least facilitate determining the predetermined amount of time based on a prior history of the passenger via adaptive learning.

Also in an exemplary embodiment, the first input includes a speech command from the passenger; and the one or more first sensors include one or more microphones that are configured to receive the speech command from the passenger.

Also in an exemplary embodiment, the instructions include audio instructions; and the system further includes a speaker that that is configured to provide the instructions.

Also in an exemplary embodiment, the instructions include visual instructions; and the system further includes a display screen that is configured to provide the instructions.

Also in an exemplary embodiment, the instructions inform the passenger to engage a particular input device in a particular directional manner within the predetermined amount of time, based at least in part on a proximity of the passenger to the particular input device; and the one or more second sensors include one or more input sensors that are configured to receive the second input as to engagement of the particular input device in the particular directional manner within the predetermined amount of time.

Also in an exemplary embodiment, the instructions inform the passenger to engage the particular input device that is usually used for a first vehicle function; and the second input is received via the one or more input sensors as to the engagement of the particular input device for executing the request with respect to a second vehicle function that is different from and unrelated to the first vehicle function.

Also in an exemplary embodiment, the instructions inform the passenger to perform a particular gesture, unrelated to any input devices of the vehicle, within the predetermined amount of time; and the one or more second sensors include one or more cameras that are configured to receive the second input as to the particular gesture within the predetermined amount of time.

Also in an exemplary embodiment, the instructions inform the passenger to swipe a steering wheel of the vehicle via a hand or finger of the passenger within the predetermined amount of time; and the second input is received via the one or more cameras as to the swiping of the steering wheel of the vehicle via the hand or finger of the passenger within the predetermined amount of time.

Also in an exemplary embodiment, the system is configured to be utilized by the passenger in requesting a plurality of different vehicle actions, including opening and closing windows, adjusting distance thresholds for cruise control, adjusting volume for sound for a navigation system of the vehicle, and adjusting zoom of a display of the navigation system.

In another exemplary embodiment, a vehicle is provided that includes a body, a microphone, a processor, and one or more additional sensors. The microphone is disposed within the body, and is configured to receive a first input from a passenger of the vehicle pertaining to a request of the passenger, the first input including a verbal command of the passenger. The processor is configured to at least facilitate providing instructions to the passenger for providing an additional input pertaining to the request within a predetermined amount of time. The one or more additional sensors are of a different sensor modality from the microphone, the one or more additional sensors configured to receive a second input from the passenger pertaining to the request, in response to the instructions, within the predetermined amount of time, the second input received via an input device that is engaged by the passenger. The processor is further configured to at least facilitate interpreting the second input; and performing a vehicle action corresponding to the request based on the interpreting of the second input, wherein the vehicle action is different than what the input device is typically used for.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for interacting with passengers of the vehicle, in accordance with exemplary embodiments;

FIG. 2 is a flowchart of a process for interacting with passengers of a vehicle, and that can be implemented in connection with the vehicle of FIG. 1, including the control system thereof, in accordance with an exemplary embodiment;

FIGS. 3 and 4 depict exemplary illustrations of a sub-process of the process of FIG. 2, corresponding to interaction with a passenger leading up to a timer that is utilized in the process, in accordance with an exemplary embodiment;

FIG. 5 depicts an exemplary illustration of a step of the process 200 pertaining to the use of the timer of the process, in accordance with an exemplary embodiment; and

FIG. 6 depicts an exemplary illustration of a step of the process 200 pertaining to active learning of the process, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

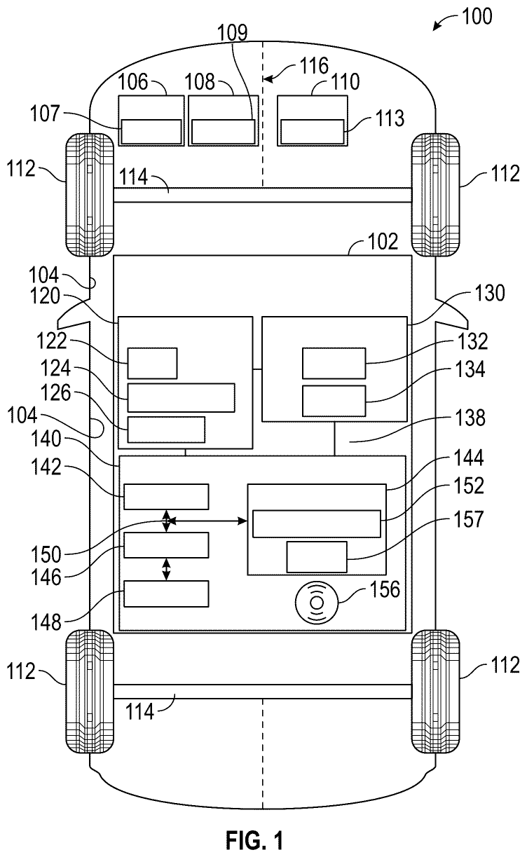

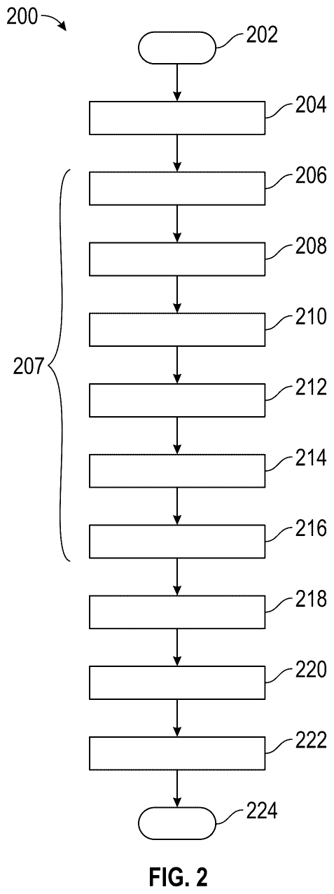

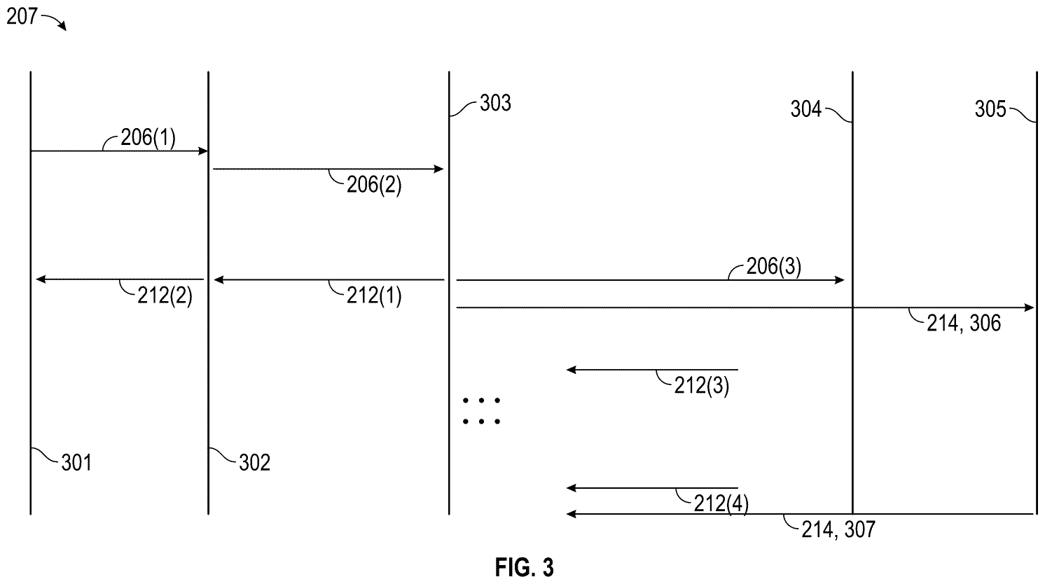

FIG. 1 illustrates a vehicle 100, according to an exemplary embodiment. As described in greater detail further below, the vehicle 100 includes, among other components, a control system 102 for interacting with one or more passengers of the vehicle via user of a virtual assistant, in accordance with exemplary embodiments. As described in greater detail further below in connection with FIG. 1 as well as the process 200 of FIG. 2 and the implementations of FIGS. 3-6, in various embodiments the control system 102 utilizes time-triggered manual inputs as part of the virtual assistant in receiving, interpreting, and implementing passenger requests.

In various embodiments, the vehicle 100 comprises an automobile, such as any one of a number of different types of automobiles, such as, for example, a sedan, a wagon, a truck, sport utility vehicle (SUV), or the like. In certain embodiments, the vehicle 100 may also comprise a motorcycle or other vehicle, such as aircraft, spacecraft, watercraft, and so on, and/or one or more other types of mobile platforms (e.g., a robot and/or another mobile platform).

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks, motorcycles, and certain other vehicles).

A drive system 110 is mounted on the chassis 116, and drives the wheels 112, for example via axles 114. In certain embodiments, the drive system 110 comprises a propulsion system having a motor 113 (e.g. that includes, in various embodiments, one or more combustion engines, electric motors, or the like).

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver (e.g., via a brake pedal 107) and/or automatically via a control system (such as the control system 102 and/or one or more other control systems).

Also in exemplary embodiments, the steering system 108 controls steering of the vehicle 100 via steering components that are controlled via inputs provided by a driver (e.g., via a steering wheel 109), and/or automatically via a control system (such as the control system 102 and/or one or more other control systems).

In the embodiment depicted in FIG. 1, the control system 102 is coupled to the braking system 106, the steering system 108, and the drive system 110, and controls operation and functionality thereof. Also in various embodiments, the control system 102 provides for interaction with one or more passengers of the vehicle via a virtual assistant, in accordance with the process 200 as depicted in FIG. 2 and the implementations of FIGS. 3-6 and as described further below in connection therewith.

Also as depicted in FIG. 1, in various embodiments, the control system 102 includes a sensor array 120, a display 130, and a controller 140, as described in greater detail below.

In various embodiments, the sensor array 120 includes various sensors that obtain sensor data as to inputs from one or more passengers of the vehicle 100 (e.g., a driver and/or one or more other passengers of the vehicle 100). In the depicted embodiment, the sensor array 120 includes one or more input sensors 122, microphones 124, and cameras 126. In certain embodiments, the sensor array 120 may further include one or more other sensors (e.g., as to receiving other inputs, and/or obtaining various operating parameters, environmental conditions, and the like).

In various embodiments, the microphones 124 obtain audible inputs from one or more passengers of the vehicle 100, including words that are spoken by the passengers. Also in various embodiments, the cameras 126 are configured to obtain visual inputs from one or more passengers of the vehicle 100, including gestures of hands or figures and/or other movements of the passengers. In various embodiments, each of the input sensors 122, microphones 124, and cameras 126 are disposed within a cabin of the vehicle 100, and obtain sensor data as to inputs from the driver and other passengers from inside the cabin of the vehicle 100.

In various embodiments, the display 130 provides information and instructions, among other content, for passengers of the vehicle 100 (including, in various embodiments, a driver as well as other passengers of the vehicle 100). As depicted in FIG. 1, in various embodiments, the display 130 includes an audio component 132 (including one or more speakers) for displaying audio instructions and other information and content for the passengers, in addition to a visual (or video) component 134 (including one or more display screens) for displaying visual instructions and other information and content for the passengers. In certain embodiments, the display 130 may also include, among other possibilities, a display screen, or head up display, or a projector that projects images on items, and/or in other embodiments controlling the light of or around the button, knob, or other input device, such as by blinking, rotating, and/or indicating to the user which button, or the like); and/or one or more other types of apparatus for providing indications, such as one or more haptic indications (e.g., rotating the steering wheel), and/or blinking lights and/or buttons, and so on.

In various embodiments, the controller 140 is coupled to the sensor array 120 and the display 130. Also in various embodiments, the controller 140 receives sensor data from the sensor array 120, interprets and processes the sensor data, and provides instructions and other information and content based thereon via the display 130. Also in various embodiments, the controller 140 controls various vehicle actions (e.g., including braking, steering, vehicle movement, cruise control settings, vehicle movement and operation, window operation, and providing of navigation and other audio visual information and content, including based on the inputs obtained from the passengers and the interpretation and determinations made therefrom). In various embodiments, the controller 140 is further coupled to the braking system 106, steering system 108, and drive system 110, among various other vehicle components (e.g., including a navigation system, and other non-depicted components) and controls operation thereof.

In various embodiments, the controller 140 provides these functions in accordance with the steps of the process 200 that is depicted in FIG. 2 and described in greater detail further below in connection therewith and further in connection with the implementations of FIGS. 3-6, also a described in greater detail further below.

As depicted in FIG. 1, in various embodiments, the controller 140 comprises a computer system (also referred to herein as computer system 140), and includes a processor 142, a memory 144, an interface 146, a storage device 148, and a computer bus 150.

The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIG. 2 and implementations of FIGS. 3-6 and as described further below in connection therewith.

The memory 144 can be any type of suitable memory, including various types of non-transitory computer readable storage medium. In certain examples, the memory 144 is located on and/or co-located on the same computer chip as the processor 142. In the depicted embodiment, the memory 144 stores the above-referenced program 152 along with stored values 157 (e.g., look-up tables, thresholds, and/or other values with respect to the process 200).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 of FIG. 2 and implementations of FIGS. 3-6 and as described further below in connection therewith. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a flowchart of a process 200 for interacting with passengers of a vehicle, in accordance with an exemplary embodiment. In various embodiments, the process 200 can be implemented in connection with the vehicle 100 of FIG. 1, including the control system 102 thereof. The process will also be described further below in connection with FIGS. 3-6, which depict exemplary illustrations of certain steps of the process 200.

As depicted in FIG. 2, in various embodiments the process 200 begins when a virtual assistant made for the vehicle is active (step 202). In various embodiments, this may comprise a default feature of the vehicle 100, and/or may be determined via user inputs via one or more user input sensors 122 of FIG. 1, or the like. As used throughout this Application, the term “passengers” may refer to a driver of the vehicle 100 and/or one or more other passengers of the vehicle 100.

In various embodiments, sensor data is obtained (step 204). Specifically, in certain embodiments, sensor data is obtained from the sensor array 120 of FIG. 1, including as to user inputs from one or more passengers of the vehicle 100 (e.g., including via the input sensors 122, microphones 124, and cameras 126 of the sensor array 120 of FIG. 1).

In various embodiments, one or more first inputs are determined (step 206). The first inputs include an initial indication from a passenger that the passenger has a request to be implemented via the control system 102 of FIG. 1. In certain embodiments, the first input comprises a verbal input via spoken words from the passenger (e.g., “zoom navigation display”, “roll down window”, “change cruise control setting”, and so on) that are captured via one or more microphones 124 of FIG. 1. In various embodiments, the nature of the first input is determined by a processor (such as the processor 142 of FIG. 1) based on the sensor data. In various embodiments, the “first input” may also include some initial interpretation by the processor 142 (and/or via a remote server), such as some natural language understanding, or the like. As described above, in certain embodiments the request pertains to a request of one or more passengers of the vehicle 100, with the request being initiated by the passenger. Alternatively, in certain embodiments, the request may instead be initiated by the vehicle 100 itself and/or via one or more devices and/or systems thereof. For example, in certain embodiments, a system of the vehicle 100 may proactively offer suggestions and/or other requests to the user (e.g., due to some event or other trigger which is not a request from the user) and it might also include a suggestion to use some button/knob (and/or other device) in the system as feedback.

Also in various embodiments, context is determined (step 208). In various embodiments, the context includes additional information pertaining to the request of the passenger. In various embodiments, the context may comprise a location of the passenger making the request, for example including a location relative to the structure of the vehicle 100 (e.g., a driver seat, a front passenger seat, a second row location such as left, middle, or right in the second row, or a third row, and so on), and/or including a location relative to the one or more input devices and/or to the steering wheel 109, and so on. Also in certain embodiments, the context may also include values of one or more vehicle parameters, states, and/or conditions that may pertain to the request (e.g., such as whether a cruise control functionality for the vehicle 100 is currently active, whether windows of the vehicle 100 are currently up or down, and so on). In various embodiments, the context is determined via a processor (such as the processor 142 of FIG. 1) based on the sensor data.

In various embodiments, a strategy is selected (step 210). In various embodiments, a processor (such as the processor 142 of FIG. 1) determines an optimal strategy for soliciting further input from the passenger based on the sensor data, the first input, and the context. In various embodiments, the strategy includes a selected means for the passenger to provide further input as to the request. For example, in certain embodiments, the strategy may include the user's engagement of a particular input device (e.g., that may be near the passenger), and/or for the passenger to make a certain gesture or to tap or otherwise contact a particular part or device of the vehicle 100 (such as the steering wheel), and so on. In various embodiments, the strategy is selected based on the type of request along with the location of the passenger, including the proximity of the passenger to one or more input devices, other parts or devices of the vehicle 100, and so on. Also in certain embodiments, the strategy may also pertain to fulfilling a request of a passenger in a particular seat location that pertains to the specific seat location (e.g., a passenger in the back left of the vehicle 100 may ask to increase audio volume for his or her seat, and/or for a particular audio zone in proximity to the particular seat, and so on). In one such embodiment, the strategy may also allow the passenger to control the volume (or other vehicle feature) using the up/down button of the window (one that is used to open/close window). In this example, any button or other control device of the vehicle 100 (e.g., that can be pressured up/down and/or rotated, etc.) can be effectively used as a multi-controller to control other aspects of vehicle functionality.

In various embodiments, instructions are provided for the passenger (step 212). In various embodiments, a processor (such as the processor 142 of FIG. 1) provides instructions for the passenger in accordance with the strategy of step 210. In various embodiments, the instructions inform the passenger as to how the passenger is to provide additional and more specific inputs as to the request.

In certain embodiments, the additional inputs pertain to an extent or degree of a continuous action with a spectrum of possible outcomes, such as an amount of zooming in or out of a navigation or other display, an amount of opening or closing of the windows, an amount of increase or decrease in audio for infotainment for the vehicle 100, an amount of change in one or more cruise control settings, and so on. Also in certain embodiments, the instructions call for the passenger to engage a particular input device in a specific directional manner (e.g., clockwise or counterclockwise rotation of a rotary knob, or the like) that is detected via one or more input sensors 122 of FIG. 1. In certain other embodiments, the instructions call for the passenger to make one or more gestures and/or other movements (e.g., such as raising an arm in a particular direction, tapping or swiping the steering wheel or other device of location of the vehicle 100 a predetermined number of times, or the like) that is detected via the cameras 126 of FIG. 1. In various embodiments, the various possible instructions (e.g., input device based or gesture based) are based on the strategy as determined in step 208, for example based on the type of the request, the location of the passenger and proximity to input devices and/or other devices or locations of the vehicle 100, and so on.

In various embodiments, the instructions are provided during step 212 via the display 130 of FIG. 1 (e.g., a display screen, or head up display, or a projector that projects images on items, and/or in other embodiments controlling the light of or around the button, knob, or other input device, such as by blinking, rotating, and/or indicating to the user which button, or the like) in accordance with instructions provided by the processor 142. In certain embodiments, an audio description of the instructions is provided via the audio component 132 of the display 130. In certain other embodiments, a visual description of the instructions is provided via the visual component 134 of the display 130. In certain embodiments, one or more other indications may be provided, such as one or more haptic indications (e.g., rotating the steering wheel), and/or blinking lights and/or buttons, and/or one or more other indications (e.g., such as those described above with respect to the display).

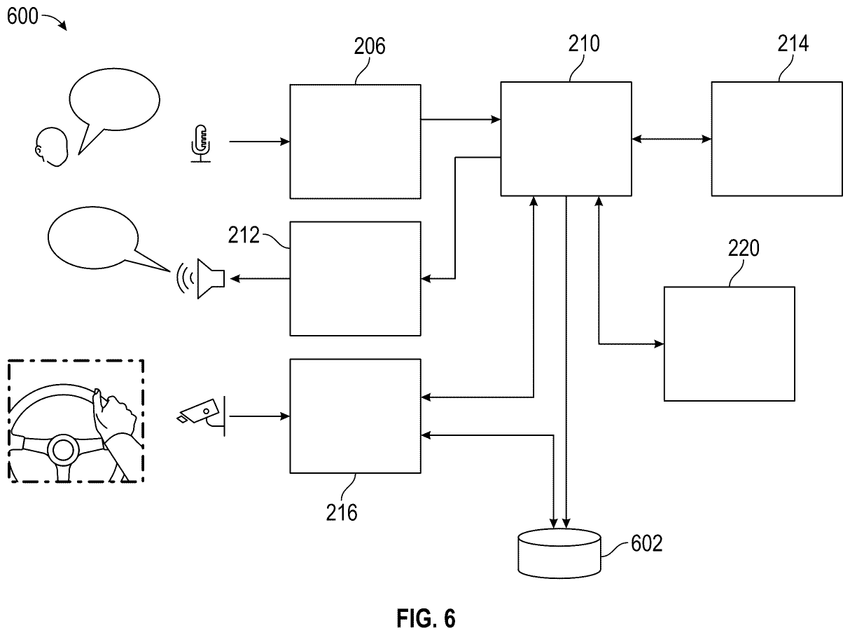

In various embodiments, a timer is initiated (step 214). In various embodiments, the timer corresponds to a predetermined, finite amount of time in which the passenger is provided to respond to the instructions. Accordingly, in various embodiments, as the passenger responds to the instructions within this predetermined amount of time (e.g., by making a specified gesture, engaging a rotary knob, tapping or swiping the steering wheel, or the like), the processor 142 will recognize this as a response to the instructions, rather than an inadvertent action. In various embodiment, the predetermined amount of time may be stored in the memory 144 of FIG. 1 as a stored value 157 therein. Also in various embodiments, the predetermined amount of time may vary, and may be customized for different passengers based on prior history, for example as described further below in connection with FIG. 6.

In various embodiments, one or more second inputs from the passenger are received, via sensors of a different modality as to the sensors that received the first inputs (e.g., different from a speech sensor, or microphone, as was used to receive the first inputs in certain embodiments). Specifically, in various embodiments, one or more additional sensors of the sensor array 120 are utilized in obtaining sensor data as to the additional inputs (also referred to as the “second inputs” 216) that are provided by the passenger in response to the instructions. For example, in certain implementations in which the second inputs relate to the passenger's engagement of an input device (such as a rotary knob), the sensor data as to the second inputs may be obtained via one or more input sensors 122 of FIG. 1. Conversely, in certain other implementations in which the second inputs relate to the passenger's gestures and/or tapping or touching one or more other devices or locations of the vehicle 100 (such as swiping a steering wheel), then sensor data as to the second inputs may be obtained via one or more cameras 126 of FIG. 1.

In various embodiments, the second inputs are interpreted (step 218). Specifically, in various embodiments, the second inputs are interpreted via the processor 142 of FIG. 1, in determining, with greater, precision, the request of the passenger. For example, in various embodiments, the interpreting of the second inputs may comprise an extent to which the passenger is requesting a display screen to be zoomed in or out, or the extent to which the volume of an infotainment system is requested to be turned up or down, or the extent to which the windows are to be opened or closed, or the extent of a change in one or more cruise control thresholds or settings, and so on.

In various embodiments, one or more actions are taken (step 220). Specifically, in certain embodiments, the processor 142 of FIG. 1 provides instructions for one or more other vehicle systems to implement the desired actions (for example as described above in connection with step 218), which are then implemented via the vehicle systems. In various embodiments, the actions are taken, via the determinations and instructions of one or more processors, based on input that is provided via the user using one or more input devices that are utilized in a manner that is different than what the device is typically used for, based on temporary control that is provided to the user by the processor for this purpose. For example, in certain embodiments, any available rotary knob, button, and/or other input device may be utilized via temporarily control that is provided to the user for one or more functions that are typically unrelated to the input device (e.g., by providing the user with temporary control for one or more other system settings). For example, in certain embodiments, a button that is usually utilized for opening/closing a window can be temporarily utilized for turning volume up and down; and/or a button on a back seat that is usually used for air direction may be used to control the channel on a television and/or other entertainment display option, among other variations in different embodiments, and so on.

Also in various embodiments, adaptive learning is performed (step 222). In various embodiments, adaptive learning is performed via the processor 142 of FIG. 1 as to one or more habits, tendencies, or the like, of the passenger, including for example as to how long the particular passenger typically takes to provide the second inputs of step 216, and so on. In various embodiments, the adaptive learning is utilized in updating the thresholds that are used for the timer of step 214, among other possible utilization of the adaptive learning. In various embodiments, the resulting values (e.g., as to timer thresholds) are saved in the memory 144 of FIG. 1 as stored values 157 therein. An illustration as to an exemplary implementation of the adaptive learning of step 222 is depicted in FIG. 6, and is described further below in condition therewith. In certain embodiments, the learning may be performed with respect to one or more users, and/or with respect to one or more other vehicles, and so on.

In various embodiments, the process 200 then terminates at step 224.

With reference to FIG. 3, an exemplary illustration is provided for a sub-process 207 of the process 200 of FIG. 2, in accordance with an exemplary embodiment. Also in an exemplary embodiment, the sub-process 207 corresponds to interaction with a passenger leading up to a timer that is utilized in the process (for example corresponding to steps 206-216 of FIG. 2). In accordance with an exemplary embodiment, the illustration of FIG. 3 corresponds to an implementation in which the passenger is prompted to provide the second inputs via an input device (e.g., a rotary knob that is turned clockwise or counterclockwise, in one embodiment).

As depicted in FIG. 3, in an exemplary embodiment, one or more first inputs 206(1) are received from a driver 301 (e.g., corresponding to a first set of inputs of step 206 of FIG. 2) (e.g., “please lower navigation voice”). In one exemplary embodiment, the request is further manifested via one or more additional first inputs 206(2) via a speech interface 302, including a command (e.g., to lower the navigation volume). As depicted in FIG. 3, in certain embodiments, 212(1) represents the concept or logical representation of the instruction, and 212(2) represents the specific manifestation of the concept. Also as depicted in FIG. 3, additional instructions are provided o the driver 301 (e.g., with a statement such as the following: “to lower the navigation voice, rotate the knob counterclockwise now, or with an instruction from the virtual assistant to first reduce the navigation volume based on a determination/logic and a notification that the user can “further reduce or increase the volume using the rotatable knob”, or the like).

In various embodiments, in accordance with a dialog manager (or display) 303, additional inputs 206(3) are received from the user (e.g., the user's engagement of a rotary knob, and e.g., with reference to 212(3) . . . 212(4) and the starting 306 and ending 307 of the timer), in various embodiments, along some time frame t₁-tn the user may rotate the knob or other device, and an event may occur and be detected as to the knob (or other device) angle, and then one or more functions (e.g., navigation volume) may be updated based upon this. Alternatively, in certain other embodiments, the system can also provide further inputs to the user to improve the user input. For example, in one embodiment, if the user is using a gesture of swiping over the steering wheel, the system might tell him to make bigger gestures (so would be detected better) or smaller, or indication it will terminate the interaction (e.g., “rotary knob going back to normal use”), and so on.

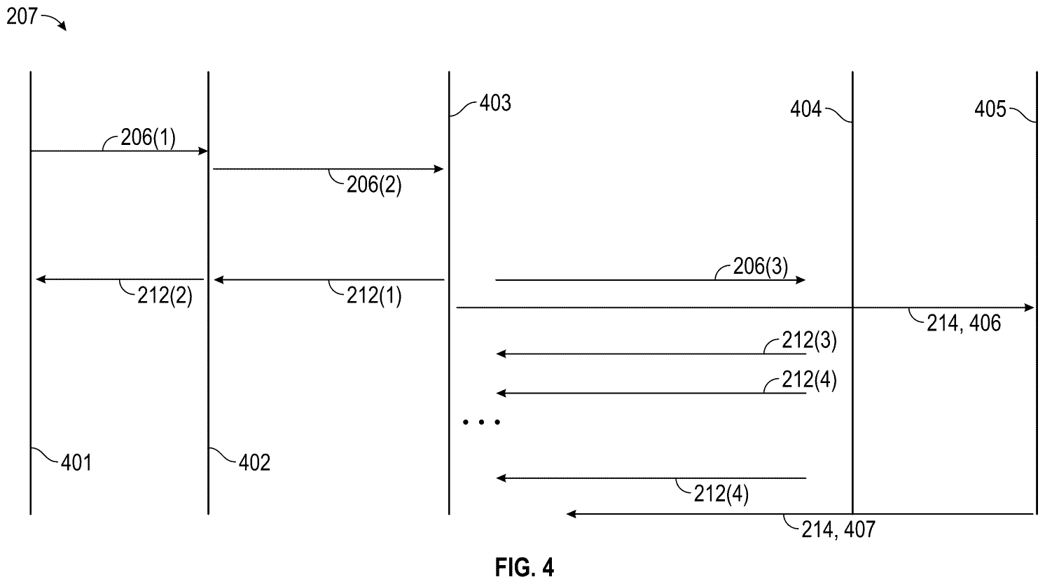

With reference to FIG. 4, another exemplary illustration is provided for a sub-process 207 of the process 200 of FIG. 2, in accordance with an exemplary embodiment. In accordance with an exemplary embodiment, the illustration of FIG. 4 corresponds to an implementation in which the passenger is prompted to provide the second inputs without an input device (e.g., via one or more gestures of the passenger).

As depicted in FIG. 4, in an exemplary embodiment, one or more first inputs 206(1) are received from a driver 401 (e.g., corresponding to a first set of inputs of step 206 of FIG. 2) (e.g., “zoom out”). In one exemplary embodiment, the request is further manifested via one or more additional first inputs 206(2) via a speech interface 402, including a command (e.g., to zoom out for the display). As depicted in FIG. 4, in certain embodiments, a first instruction 212(1) is provided to the speech interface 402 (e.g., first inputs 206(1) correspond to an initial broad indication from the passenger as to the request (e.g., to provide instructions to zoom out). Also as depicted in FIG. 4, additional instructions 212(2) are provided to the driver 401 (e.g., with a statement such as the following: “to zoom out, swipe left on the steering wheel now”).

In various embodiments, in accordance with a dialog manager (or display) 403, additional inputs 206(3) are received from the user (e.g., the activation of a 126 and/or other sensor of FIG. 1). Also in various embodiments, the timer is utilized (corresponding to step 214 of FIG. 2), including the starting 406 of the timer and the ending 407 of the timer.

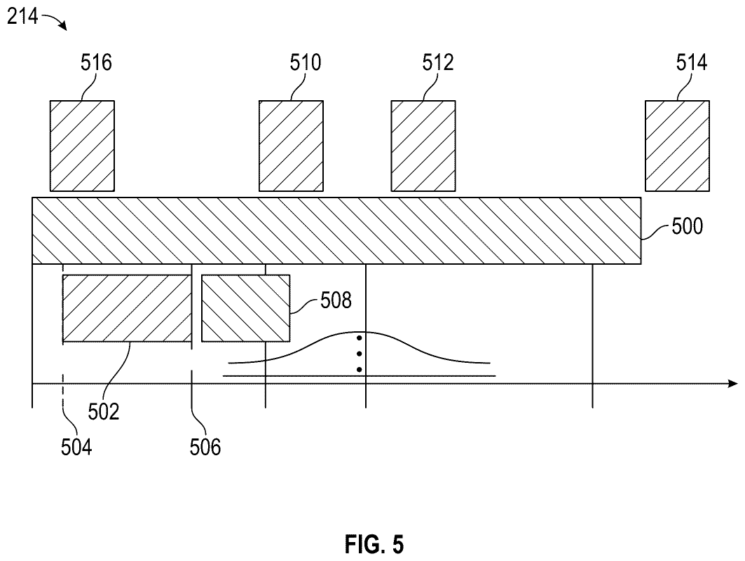

FIG. 5 depicts an exemplary illustration of a step of the process 200 pertaining to the use of the timer of the process (e.g., corresponding to step 214 of FIG. 2), in accordance with an exemplary embodiment. As depicted in FIG. 5, in an exemplary embodiment, a user speech command 502 (e.g., corresponding to the first input 206 of FIG. 2) is received between a start period 504 and an end period 506, followed by a system dialog 508. In various embodiments, as part of the timer, a passenger's response at point “A” 510 represents an early manual entry after a prompt (e.g., the instructions), whereas a passenger's response at point “B” 512 represents a later manual entry after the prompt. Conversely, also in various embodiments: a passenger's response at point “C” 514 represents a very late manual entry after the prompt, whereas a passenger's response at point “D” 516 represents a very early entry prior to the prompt. In various embodiments, the processor 142 customizes and adjusts the timer accordingly based on a history of actions of the passenger, for example as part of the learning of step 222 of FIG. 2. For example, in one embodiment, after the user has used the system and learned he or she can change the volume using the rotary knob (or other device) when the user asks to set the volume by voice, user might say “reduce volume” and start to rotate the knob in parallel (as he or she already knows the system will change volume based on the knob). In an exemplary embodiment, in such case, the learning (e.g., that the system needs to monitor the knob early) allows the system to avoid missing the manual input.

FIG. 6 depicts an exemplary illustration 600 of a step of the process 200 pertaining to active learning of the process (e.g., corresponding to step 222 of FIG. 2), in accordance with an exemplary embodiment in which the passenger is provided instructions for completing the request via one or more gestures that are captured via one or more cameras. As depicted in FIG. 6, in various embodiments, speech recognition is provided (corresponding to step 206), along with a dialog manager (corresponding to step 210), text to speech (corresponding to step 212), along with gesture detection (e.g., relative finger/hand detection, corresponding to step 216). Also in various embodiments, the timer is triggered (corresponding to step 214), and an updated display is provided as appropriate (corresponding to step 220). In various embodiments, internal camera images 602 are obtained (e.g., in certain embodiments, also corresponding to the second inputs of step 216). In various embodiments, learning is performed via a history of actions of the passenger, for example in customizing the timer toward the specific passenger, among other possible customizations (e.g., in certain embodiments, customizing the strategy and/or instructions based on passenger preferences, and so on).

Accordingly, methods, systems, and vehicles are provided for interacting with one or more passengers of the vehicle via a virtual assistant, in accordance with exemplary embodiments. In various embodiments, time-triggered manual inputs are utilized as part of the virtual assistant in receiving, interpreting, and implementing passenger requests for the vehicle. As described above, in various embodiments the user provides initial inputs (e.g., via voice commands) followed by additional inputs (e.g., via engagement of an input device such as a rotary knob that is captured via one or more input sensors, or via one or more gestures that are captured via one or more cameras) of a different modality or type, based on a strategy that is designed via a computer processor and that is provided to the passenger in the form of instructions that are then implemented via the user in providing the additional inputs.

It will be appreciated that the systems, vehicles, and methods may vary from those depicted in the Figures and described herein. For example, the vehicle 100 of FIG. 1, including the control system 102 and/or other components thereof, may vary in different embodiments from that depicted in FIG. 1 and/or described above in connection therewith. It will similarly be appreciated that the steps of the process 200 and implementations thereof may differ from those depicted in FIGS. 2-6, and/or that various steps of the process 200 may occur concurrently and/or in a different order than that depicted in FIGS. 2-6 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
receiving, via one or more first sensors of a vehicle, a first input from a passenger of the vehicle pertaining to a request, the one or more first sensors having a first modality;
providing instructions to the passenger for providing an additional input pertaining to the request within a predetermined amount of time, via a processor of the vehicle;
receiving, via one or more second sensors of the vehicle, a second input from the passenger pertaining to the request, in response to the instructions, within the predetermined amount of time, the one or more second sensors having a second modality that is different from the first modality;
interpreting the second input, via the processor; and
performing a vehicle action corresponding to the request based on the interpreting of the second input, via the processor.

2. The method of claim 1, wherein the predetermined amount of time is determined via the processor based on a prior history via adaptive learning.

3. The method of claim 1, wherein the first input comprises a speech command from the passenger, and is received via one or more microphones of the vehicle.

4. The method of claim 3, wherein the instructions comprise audio instructions that are provided via a speaker of the vehicle that is coupled to the processor.

5. The method of claim 3, wherein the instructions comprise visual instructions that are provided via a display screen of the vehicle that is coupled to the processor.

6. The method of claim 3, wherein:
the instructions inform the passenger to engage a particular input device in a particular directional manner within the predetermined amount of time, based at least in part on a proximity of the passenger to the particular input device; and
the second input is received via one or more input sensors as to engagement of the particular input device in the particular directional manner within the predetermined amount of time.

7. The method of claim 6, wherein:
the instructions inform the passenger to engage the particular input device that is usually used for a first vehicle function; and
the second input is received via the one or more input sensors as to the engagement of the input device for executing the request with respect to a second vehicle function that is different from and unrelated to the first vehicle function.

8. The method of claim 3, wherein:
the instructions inform the passenger to perform a particular gesture, unrelated to any input devices of the vehicle, within the predetermined amount of time; and
the second input is received via one or more cameras as to the particular gesture within the predetermined amount of time.

9. The method of claim 8, wherein:
the instructions inform the passenger to swipe a steering wheel of the vehicle via a hand or finger of the passenger within the predetermined amount of time; and
the second input is received via the one or more cameras as to the swiping of the steering wheel of the vehicle via the hand or finger of the passenger within the predetermined amount of time.

10. A system comprising:
one or more first sensors of a vehicle, the one or more first sensors configured to receive a first input from a passenger of the vehicle pertaining to a request, the one or more first sensors having a first modality;
a processor of the vehicle, the processor configured to at least facilitate providing instructions to the passenger for providing an additional input pertaining to the request within a predetermined amount of time; and
one or more second sensors of the vehicle, the one or more second sensors configured to receive a second input from the passenger pertaining to the request, in response to the instructions, within the predetermined amount of time, the one or more second sensors having a second modality that is different from the first modality;
wherein the processor is further configured to at least facilitate:
interpreting the second input; and
performing a vehicle action corresponding to the request based on the interpreting of the second input.

11. The system of claim 10, wherein the processor is further configured to at least facilitate determining the predetermined amount of time based on a prior history of the passenger via adaptive learning.

12. The system of claim 10:
wherein the first input comprises a speech command from the passenger; and
the one or more first sensors comprise one or more microphones that are configured to receive the speech command from the passenger.

13. The system of claim 12, wherein:
the instructions comprise audio instructions; and
the system further comprises a speaker that that is configured to provide the instructions.

14. The system of claim 12, wherein:
the instructions comprise visual instructions; and
the system further comprises a display screen that is configured to provide the instructions.

15. The system of claim 12, wherein:
the instructions inform the passenger to engage a particular input device in a particular directional manner within the predetermined amount of time, based at least in part on a proximity of the passenger to the particular input device; and
the one or more second sensors comprise one or more input sensors that are configured to receive the second input as to engagement of the particular input device in the particular directional manner within the predetermined amount of time.

16. The system of claim 15, wherein:
the instructions inform the passenger to engage the particular input device that is usually used for a first vehicle function; and
the second input is received via the one or more input sensors as to the engagement of the particular input device for executing the request with respect to a second vehicle function that is different from and unrelated to the first vehicle function.

17. The system of claim 12, wherein:
the instructions inform the passenger to perform a particular gesture, unrelated to any input devices of the vehicle, within the predetermined amount of time; and
the one or more second sensors comprise one or more cameras that are configured to receive the second input as to the particular gesture within the predetermined amount of time.

18. The system of claim 17, wherein:
the instructions inform the passenger to swipe a steering wheel of the vehicle via a hand or finger of the passenger within the predetermined amount of time; and
the second input is received via the one or more cameras as to the swiping of the steering wheel of the vehicle via the hand or finger of the passenger within the predetermined amount of time.

19. The system of claim 10, wherein the system is configured to be utilized by the passenger in requesting a plurality of different vehicle actions, including opening and closing windows, adjusting distance thresholds for cruise control, adjusting volume for sound for a navigation system of the vehicle, and adjusting zoom of a display of the navigation system.

20. A vehicle comprising:
a body;
a microphone disposed within the body, the microphone configured to receive a first input from a passenger of the vehicle pertaining to a request of the passenger, the first input comprising a verbal command of the passenger;
a processor configured to at least facilitate providing instructions to the passenger for providing an additional input pertaining to the request within a predetermined amount of time; and
one or more additional sensors, of a different sensor modality from the microphone, the one or more additional sensors configured to receive a second input from the passenger pertaining to the request, in response to the instructions, within the predetermined amount of time, the second input received via an input device that is engaged by the passenger;
wherein the processor is further configured to at least facilitate:
interpreting the second input; and
performing a vehicle action corresponding to the request based on the interpreting of the second input, wherein the vehicle action is different than what the input device is typically used for.
